(19) United States
(12) Patent Application Publication
(10) Pub. No.: US 2022/0292990 A1
(43) Pub. Date: Sep. 15, 2022

(54) METHOD AND ELECTRONIC DEVICE FOR GENERATING AT LEAST ONE EOSID TRAJECTORY FOR AT LEAST ONE RUNWAY, RELATED COMPUTER PROGRAM AND ELECTRONIC FLIGHT MANAGEMENT SYSTEM

(71) Applicant: THALES, Courbevoie (FR)

(72) Inventors: Dorian MARTINEZ, Toulouse (FR); Philippe CHAIX, Toulouse (FR)

(21) Appl. No.: 17/692,676

(22) Filed: Mar. 11, 2022

(30) Foreign Application Priority Data
Mar. 12, 2021 (FR) 21 02454

(51) Int. Cl. G08G 5/00; G05D 1/06

(52) U.S. Cl. CPC G08G 5/0034; G08G 5/0065; G05D 1/0661

(57) ABSTRACT

The invention relates to a method for generating at least one engine-out standard instrument departure trajectory, called EOSID trajectory, for at least one take-off runway, each EOSID trajectory being associated with a respective take-off runway.

The method is implemented by an electronic generating device and comprises, for each take-off runway, the following steps:
acquiring a set of characteristic(s) relating to the take-off runway, the set of characteristic(s) comprising an orientation of the axis of the take-off runway with respect to North;
calculating, from the acquired set of characteristic(s), at least one flight segment of a respective EOSID trajectory, the heading of each segment being defined with respect to the orientation of the take-off runway axis; and
generating each EOSID trajectory from the calculated flight segment(s).

### CROSS-REFERENCE TO RELATED APPLICATIONS

This application is a U.S. non-provisional application claiming the benefit of French Application No. 21 02454, filed on Mar. 12, 2021, which is incorporated herein by reference in its entirety.

### FIELD

The present invention relates to a method for generating at least one engine out standard instrument departure (EOSID) trajectory for at least one take-off runway, the method being implemented by an electronic generating device.

The invention also relates to a non-transitory computer-readable medium including a computer program comprising software instructions which, when executed by a computer, implement such a generating method.

The invention also relates to such an electronic device for generating at least one EOSID trajectory, as well as to an electronic flight management system comprising such an electronic generating device.

The invention relates to the field of on-board systems, and more particularly to systems involving an avionics navigation computer, such as the flight management system (FMS), or a non-avionics on-board tablet system implementing flight management or optimisation functions, such as an EFB (Electronic Flight Bag). The invention further relates to the field of computing environments comprising modelled embedded systems, such as simulators; or computing environments incorporating a navigation computer model, such as a Flight Management System Software Development Kit (FMS SDK).

### BACKGROUND

Currently, most flight management systems have an EOSID option to automatically manage the aircraft's departure trajectory in the event of engine failure(s) during take-off. The air operator must then purchase the codes of the EOSID trajectories for each of the airports at which it operates from a provider of navigation databases, also known as NAVDBs.

Patent FR 3 043 487 B1 concerns the management of the trajectory of an aircraft, in particular in the event of the failure of one or more engines, with the reception of one or more EOSID trajectories from a navigation database.

However, the cost of purchasing these EOSID trajectories from navigation database providers is relatively high, and some airlines prefer not to use them. If necessary, the pilot must then reconstruct the EOSID trajectory himself in the form of a secondary flight plan, in order to anticipate possible engine failure(s) on take-off. In addition, in the event of a confirmed engine failure on take-off, the pilot cannot activate the EOSID option within the flight management system, and therefore does not benefit from the greater ease of piloting that comes with activating this option.

### SUMMARY

The aim of the invention is then to propose a method, and an associated electronic device, for generating at least one EOSID trajectory, allowing the EOSID option of the flight management system to be used even if the EOSID trajectories are not contained in the navigation database on board the aircraft.

To this end, the subject-matter of the invention is a method for generating at least one engine-out standard instrument departure trajectory, also known as EOSID trajectory, for at least one take-off runway, each EOSID trajectory being associated with a respective take-off runway, the method being implemented by an electronic generating device and comprising, for each take-off runway, the following steps:
acquiring a set of characteristic(s) relating to the take-off runway, the set of characteristic(s) comprising an orientation of the axis of the take-off runway with respect to North;
calculating, from the acquired set of characteristic(s), at least one flight segment of a respective EOSID trajectory, the heading of each segment being defined with respect to the orientation of the take-off runway axis; and
generating each EOSID trajectory from the calculated flight segment(s).

With the generating method according to the invention, each EOSID trajectory is then automatically generated via the acquisition of the set of characteristics relating to the take-off runway, and then the calculation of the or each of the flight segments of said trajectory from the acquired set of characteristics.

This automatic generating of one or more EOSID trajectories is for example performed in advance, and the generated EOSID trajectory(s) is/are then typically stored in a memory of the flight management system. Alternatively, this automatic generating of EOSID trajectory(s) is performed on the fly during the flight preparation phase, typically during the initialisation of the flight management system.

In other beneficial aspects of the invention, the generating method comprises one or more of the following features, taken in isolation or in any technically possible combination:
during the calculating, several successive flight segments of the respective EOSID trajectory are calculated from the acquired set of characteristic(s),

among the plurality of successive flight segments of a respective EOSID trajectory, at least two segments preferably having a heading with a different value from one segment to the other;
among the plurality of successive flight segments of a respective EOSID trajectory, at least two segments having a different type from one segment to the other;

the type of each segment preferably being in accordance with ARINC 424;

the type of each segment being preferably further selected from the group consisting of: CD, CA, FD, FA, FM, FC, HM, HA and TF;
during the acquiring, the set of characteristic(s) further comprise(s) a take-off runway altitude; and during the calculating, an altitude constraint of at least one flight segment of the respective EOSID trajectory is defined from a height relative to the take-off runway altitude;
each generated EOSID trajectory further comprises an orientation indicator, taken into account when selecting a respective EOSID trajectory among a plurality of EOSID trajectories associated with the take-off runway, the selection being made according to the positioning of said take-off runway among a plurality of take-off runways of a respective airport;
the heading value of a respective segment is changeable by a user for at least one flight segment; and
each calculated flight segment further comprises a distance to be flown along said segment;

the value of said distance being preferably predefined;

the value of said distance being even more preferably changeable by a user.

The invention also relates to a non-transitory computer-readable medium including a computer program comprising software instructions, which, when carried out by a computer, implement a generating method as defined above.

The invention also concerns an electronic device for generating at least one engine-out standard instrument departure trajectory, known as an EOSID trajectory, for at least one take-off runway, each EOSID trajectory being associated with a respective take-off runway, the device comprising:
an acquisition module configured to acquire, for each take-off runway, a set of characteristics relating to the take-off runway, the set of characteristic(s) comprising an orientation of the axis of the take-off runway with respect to North;
a calculation module configured to calculate, for each take-off runway and from the acquired set of characteristics, at least one flight segment of a respective EOSID trajectory, the heading of each segment being defined with respect to the orientation of the take-off runway axis; and
a generating module configured to generate, for each take-off runway, each EOSID trajectory from the calculated flight segment(s).

The invention further relates to an electronic system selected from an aircraft flight management system, also known as a Flight Management System (FMS), and a non-aircraft tablet system implementing flight management or optimisation functions, such as an EFB (Electronic Flight Bag), the electronic system comprising an electronic generating device as defined above, the device being configured to generate, for at least one take-off runway, at least one engine-out standard instrument departure trajectory of the aircraft.

### BRIEF DESCRIPTION OF THE DRAWINGS

These features and advantages of the invention will appear more clearly upon reading the following description, given solely as a non-limiting example, and made in reference to the attached drawings, in which:

FIG. 1 is a schematic representation of an aircraft comprising avionics systems, including a flight management system according to the invention, the flight management system comprising an electronic device for generating at least one engine-out standard instrument departure trajectory; and

FIG. 2 is a flowchart of a method, according to the invention, for generating at least one such engine-out standard instrument departure trajectory.

### DETAILED DESCRIPTION

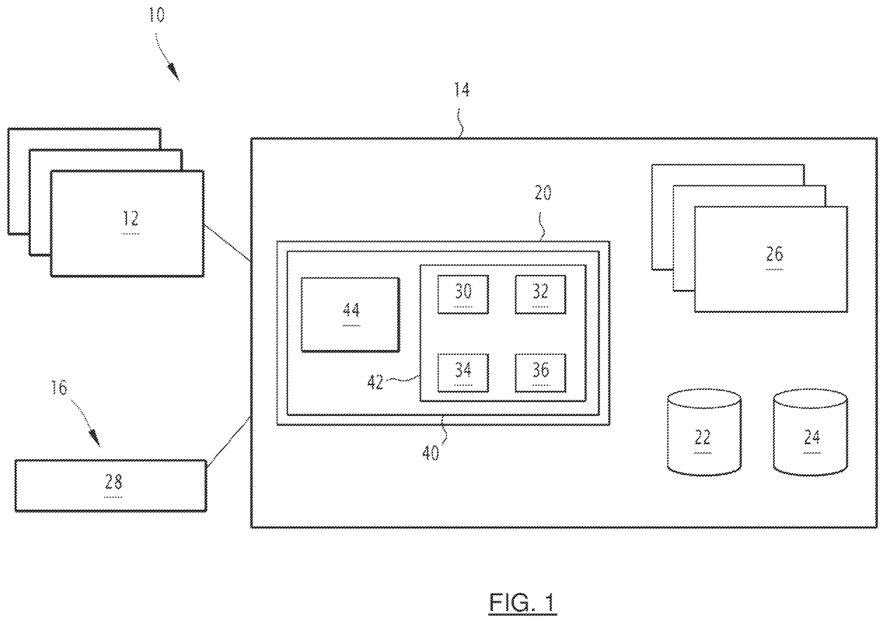

In FIG. 1, an aircraft 10 comprises a number of avionics systems 12, an electronic flight management system 14, also known as an FMS, and a user interface 16 connected to the flight management system 14.

The aircraft 10 is, for example, an aeroplane. Alternatively, the aircraft 10 is a helicopter, or a drone that can be flown remotely by a pilot.

Avionics systems 12 are known per se, and are able to transmit to the flight management system 14 and/or receive from the flight management system 14 various avionics data, for example so-called “aircraft” data, such as the position, orientation, heading or altitude of the aircraft 10, and/or so-called “navigation” data, such as a flight plan.

According to the invention, the flight management system 14 comprises an electronic device 20 for generating at least one engine-out standard instrument departure trajectory, called EOSID trajectory, for at least one take-off runway.

The flight management system 14 further comprises a navigation database 22, a performance database 24 and one or more flight management functions 26.

In the following description, the acronym SID (Standard Instrument Departure) is a procedure to be followed on departure from an airport by an aircraft operating under IFR (Instrument Flight Rules). An SID trajectory is then the trajectory associated with this procedure.

The acronym EOSID (Engine-Out SID) is the departure procedure to be followed in the event of engine failure(s). The EOSID trajectory is then the trajectory associated with this EOSID procedure.

The user interface 16 is known per se. The user interface 16 comprises, for example, a display screen 28, such as a touch screen, to allow input of interaction(s) from a user, not shown, such as the pilot or co-pilot of the aircraft 10. The display screen 28 allows the display of information, such as at least one EOSID trajectory generated by the generating device 20.

The electronic generating device 20 is configured to generate at least one EOSID trajectory for at least one take-off runway, each EOSID trajectory being associated with a respective take-off runway.

The electronic generating device 20 comprises an acquisition module 30 for acquiring, for each take-off runway, a set of characteristic(s) relating to the take-off runway; a calculation module 32 for calculating, for each take-off runway and from the acquired set of characteristic(s), at least one flight segment of a respective EOSID trajectory; and a generating module 34 for generating, for each take-off runway, each EOSID trajectory from the calculated flight segment or segments.

As an optional addition, the electronic generating device 20 further comprises a display module 36 for displaying at least one EOSID trajectory.

In the example shown in FIG. 1, the electronic generating device 20 is included in the flight management system 14.

Alternatively or additionally, the electronic generating device 20 is included in a non-aircraft tablet system implementing flight management or optimisation functions, such as the EFB.

In an alternative, not shown, the electronic generating device 20 is included in ground-based computing equipment, i.e. not on board the aircraft 10, the computing equipment incorporating a model navigation computer, such as a flight management system software development kit, also known as an FMS SDK. In this embodiment, the generating device 20 is typically included in the flight management system software development kit.

According to this alternative, the ground-based computing equipment is preferably further configured to send—via an AOC (Aeronautical Operational Control) link and to the flight management system 14 and/or the non-aircraft tablet system, such as the EFB—each EOSID trajectory generated by the electronic generating device 20.

In the example shown in FIG. 1, the electronic generating device 20 comprises an information processing unit 40 formed for example by a memory 42 and a processor 44 associated with the memory 42.

In the example shown in FIG. 1, the acquisition module 30, the calculation module 32, the generating module 34, and optionally the display module 36, are each in the form of software, or a software brick, which can be executed by the processor 44. The memory 42 of the electronic generating device 20 is in such a case capable of storing software for acquiring, for each take-off runway, a set of characteristic(s) relating to the take-off runway; software for calculating, for each take-off runway and from the acquired set of characteristic(s), at least one flight segment of a respective EOSID trajectory; and software for generating, for each take-off runway, each EOSID trajectory from the calculated flight segment or segments. As an optional addition, the memory 42 of the generating device 20 is adapted to store software for displaying at least one EOSID trajectory. The processor 44 is then able to execute each one of the acquisition software, the calculation software and the generating software, and optionally, in addition, the display software.

In a variant not shown, the acquisition module 30, the calculation module 32, and the generating module 34, and optionally, in addition, the display module 36, are each in the form of a programmable logical component, such as a FPGA (Field-Programmable Gate Array), or as a dedicated integrated circuit, such as an ASIC (Application-Specific Integrated Circuit).

When the generating device 20 is in the form of one or more software, that is to say in the form of a computer program, also called a computer program product, it is also capable of being stored on a computer-readable medium, not shown. The computer-readable medium is, for example, a medium that can store electronic instructions and be coupled with a bus from a computer system. For example, the readable medium is an optical disk, magneto-optical disk, ROM memory, RAM memory, any type of non-volatile memory (for example EPROM, EEPROM, FLASH, NVRAM), magnetic card or optical card. The readable medium in such a case stores a computer program comprising software instructions.

The navigation database 22, also referred to as a NAVDB, is typically a database containing aeronautical data, such as common aeronautical data regularly provided by an aeronautical database provider and/or user aeronautical data containing, for example, items entered by the user and/or by a company chartering the aircraft 10. The aeronautical data contained in the navigation database 22 is then used to construct geographical routes and/or procedures.

The performance database 24, also called a PERFDB, contains aerodynamic and engine parameters of the aircraft 10.

Flight management functions 26 are known per se, and include, for example, a navigation function to carry out an optimal location-finding of the aircraft 10 according to geolocation means, such as satellite geo-positioning means, VHF radio navigation beacons, or inertial navigation systems. Flight management functions 26 typically also include a flight plan function to capture geographical features that form a skeleton of the route to be followed, such as points imposed by departure and arrival procedures, waypoints, air corridors. The flight management functions 26 also include a lateral trajectory function to build a continuous trajectory from the flight plan points and respecting the performance of the aircraft 10, as well as the containment constraints, also called RNP Required Navigation Performance); a prediction function for constructing an optimised vertical profile on the lateral and vertical trajectory and giving estimates of distance, time, altitude, speed, fuel and wind in particular on each point, at each change of piloting parameter and at destination, these estimates being intended to be displayed on the display screen 28. The flight management functions 26 also include, for example, a guidance function to guide the aircraft 10 in lateral and vertical planes along its three-dimensional trajectory, while optimising its speed, using the information calculated by the prediction function.

The acquisition module 30 configured to acquire, for each take-off runway, a set of characteristics relating to the corresponding take-off runway, the set of characteristic(s) comprising an orientation of the axis of the take-off runway with respect to North; Optionally, in addition, the set of characteristic(s) further comprises an altitude of the corresponding take-off runway, such as the altitude of a runway threshold of said runway.

The calculation module 32 is configured to calculate, for each take-off runway and from the acquired set of characteristic(s), at least one flight segment of a respective EOSID trajectory.

In particular, the calculation module 32 is configured to calculate the heading of each segment with respect to the orientation of the take-off runway axis relative to North. The calculation module 32 is, for example, configured to calculate the heading of each segment as an angle of predefined value with respect to said runway axis.

When optionally the set of characteristic(s) further comprises the take-off runway altitude, the calculation module 32 is preferably configured to calculate an altitude constraint of at least one flight segment of the respective EOSID trajectory from a height relative to the take-off runway altitude. The calculation module 32 is then configured to calculate each altitude constraint as a height relative to said altitude of the take-off runway, said height preferably being a predefined height.

The calculation module 32 is thus configured to calculate one or more flight segments for each respective EOSID trajectory, the headings of which, and if applicable the altitude constraint(s), are calculated from the axis of the take-off runway relative to North, and if applicable from the altitude of said runway.

The calculation module 32 is preferably configured to calculate several successive flight segments for each respective EOSID trajectory from the acquired set of characteristic(s). When several successive flight segments are calculated for a respective EOSID trajectory, at least two flight segments preferably have a different heading value from one segment to the other.

The calculation module 32 is for example configured to calculate three successive flight segments for each respective EOSID trajectory.

When several successive flight segments are calculated for a respective EOSID trajectory, at least two flight segments preferably have a different type from one segment to the other.

The type of each segment is typically in accordance with ARINC 424. The type of each segment is for example selected from the group consisting of: CD (Course to DME Arc), CA (Course to Altitude), FD (Fixed to DME Arc), FA (Fixed to Altitude), FM (Fixed Manual), FC (Course from Fix), HM (Hold Manual), HA (Hold to Altitude) and TF (Track to Fix).

In addition, the calculation module 32 is configured to calculate, for each flight segment, a distance to be flown along said segment. The value of said distance is preferably predefined for each flight segment.

Optionally, in addition, the value of said distance is furthermore changeable by the user.

Optionally, in addition, the heading value of a respective segment is also changeable by said user for at least one flight segment.

Optionally, in addition, the calculation module 32 is further configured to calculate an orientation indicator, taken into account for the selection of a respective EOSID trajectory among a plurality of EOSID trajectories associated with the take-off runway, the selection then being made in function of said indicator and the positioning of said take-off runway among a plurality of take-off runways of a respective airport.

According to this optional addition, the calculation module 32 is preferably configured to calculate an orientation indicator for each flight segment, the orientation indicator then being the same for all flight segments of a same EOSID trajectory, the orientation indicator being associated with each generated EOSID trajectory.

The calculation module 32 is then configured, for example, to calculate the flight segments in Table 1 below.

TABLE 1

| | Segment | | | | | | | |
|---|---|---|---|---|---|---|---|---|
| EOSID name | name | PS | LT | C (°) | AT | AC (ft) | D (Nm) | Ov |
| EOSID-L | EOSID-LA | L | CD | 0 | AT_OR_ABOVE | 1000 | 5 | FALSE |
| | EOSID-LB | L | CD | −90 | | | 2 | TRUE |
| | EOSID-LC | L | HM | −90 | | | 2 | FALSE |
| EOSID-R | EOSID-RA | R | CD | 0 | AT_OR_ABOVE | 1000 | 5 | FALSE |
| | EOSID-RB | R | CD | +90 | | | 2 | TRUE |
| | EOSID-RC | R | HM | +90 | | | 2 | FALSE |

In the example of this Table 1, three successive flight segments are calculated for each respective EOSID trajectory, the flight segments being named with the name of the trajectory, chosen from “EOSID-L” and “EOSID-R”, followed by a letter A, B or C. In other words, in this Table 1, the first three rows correspond to three successive segments for a first EOSID trajectory, called EOSID-L; and the last three segments correspond to a second EOSID trajectory, called EOSID-R.

In the example in Table 1 above, each flight segment has a name field, called “Segment Name”, followed by a PS (Preferred Side) field containing the orientation indicator, a LT (Leg Type) field containing the type of the corresponding segment, a C (Course) field expressed in degrees and containing the value of the angle with respect to the runway centreline to define the segment heading; an AT (Alt Type) field containing an altitude constraint type expressed in English among the AT constraint defining an imposed altitude, the AT_OR_ABOVE constraint defining a minimum altitude and the AT_OR_BELOW constraint defining a maximum altitude; an AC (Alt Constraint) field containing an altitude value expressed in feet, this altitude value being associated with the altitude constraint contained in the AT field; a D (Distance) field containing a distance value expressed in nautical miles or Nm, said distance value corresponding to the distance to be flown along said segment; and an Ov (Overfly) field containing an indicator in English among TRUE or FALSE indicating the necessity to fly over the end of the segment or not, the indicator being set to TRUE when it is necessary to fly over the end of said segment, and to FALSE otherwise.

The altitude value used for the altitude constraint, which is the sum of the height value contained in the AC field of the flight segment and the runway altitude, is preferably rounded up to the nearest 100 ft.

The generating module 34 is in such a case configured to generate each EOSID trajectory from said flight segment calculated by the calculation module 32. The generating module 34 is, for example, configured to generate each EOSID trajectory as a sequence, i.e. a succession, of the flight segments calculated successively by the calculation module 32 for a respective EOSID trajectory.

In the example in Table 1 above, each EOSID trajectory in this case corresponds to the succession of the three calculated flight segments.

Optionally, in addition, the display module 36 is configured to display at least one selected EOSID trajectory, said trajectory being preferably selected by the user. Optionally, in addition, an EOSID trajectory is pre-selected by the generating device 20, to facilitate subsequent selection by the user.

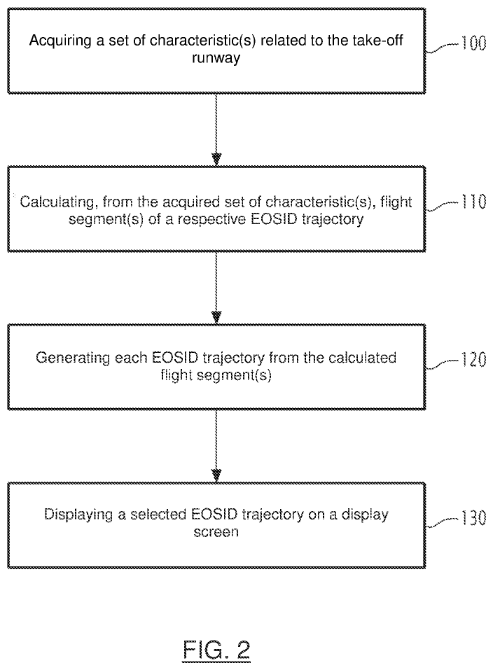

The operation of the flight management system 14, and in particular of the generating device 20, according to the invention will now be described with reference to FIG. 2 showing a flowchart of the method, according to the invention, of generating an EOSID trajectory for at least one take-off runway.

In an initial step 100, the generating device 20 acquires, via its acquisition module 30, the set of characteristic(s) relating to the take-off runway. Said set of characteristic(s) comprises the orientation of the take-off runway axis with respect to North for each take-off runway. In addition, the set of characteristic(s) further comprises the altitude of each take-off runway, typically the altitude of each runway threshold.

At the end of the acquisition step 100, the generating device 20 proceeds to the next step 110 in which it calculates, via its calculation module 32, for each take-off runway and from the set of characteristic(s) acquired in step 100, at least one flight segment of a respective EOSID trajectory.

In this calculation step 110, the heading of each segment is defined in relation to the orientation of the take-off runway axis with respect to North. Additionally, when the set of characteristic(s) further comprises a take-off runway altitude, an altitude constraint of at least one flight segment of the respective EOSID trajectory is further defined in said calculation step 110, from a height relative to the take-off runway altitude.

In the calculation step 110, several successive flight segments, for example three successive flight segments, are preferably calculated for each respective EOSID trajectory. Among the plurality of calculated flight segments, at least two flight segments preferably have a different heading value from one segment to another. Additionally or alternatively, among this plurality of successive flight segments of a respective EOSID trajectory, at least two segments preferably having a different type from one segment to the other.

Furthermore optionally, in addition, the heading value of a respective segment is also changeable by said user for at least one flight segment.

In addition or alternatively, the value of the distance to be flown along a respective segment can also be changed by the user.

In the next step 120, the generating device 20 then generates each EOSID trajectory, via its generating module 34 and from the flight segment(s) calculated during the previous step 110, this generating typically being carried out via a concatenation, or alternatively an aggregation, of the different flight segments calculated successively by the calculation module 32.

Optionally, in addition, each EOSID trajectory under consideration comprises a respective orientation indicator, the orientation indicator being taken into account for the selection of a respective EOSID trajectory from the plurality of EOSID trajectories associated with the take-off runway, said selection then being made in dependence on said indicator and the positioning of said take-off runway among the plurality of take-off runways of the respective airport.

In other words, the orientation indicator, corresponding to the PS field in Table 1 above, allows the preferred EOSID trajectory to be chosen according to the positioning of the track, with for example L on the left, R on the right and C in the centre as the orientation indicator. Furthermore, in case of an SID trajectory without an EOSID trajectory contained in the navigation database 22, if only one EOSID trajectory has been generated by the generating device 20 according to the invention, then the flight management system 14 pre-selects that one, otherwise it uses the orientation indicator coupled to the runway positioning among the different runways of the airport to pre-select the best EOSID trajectory.

In an optional step 130, the generating device 20 then displays, via its display module 36, the selected EOSID trajectory on the display screen 28.

Thus, the generating device 20 and the associated generating method according to the invention make it possible to automatically generate one or more EOSID trajectories, which then make it possible to use the EOSID option of the flight management system 14 even if EOSID trajectories are not contained in the navigation database 22, carried on board the aircraft 10.

In other words, the invention allows the crew of the aircraft 10, in particular the pilot or co-pilot, to then use the EOSID trajectory(s) thus generated, just as if the EOSID trajectory had been prepared and stored in said navigation database 22 by the provider of said database.

This allows the crew to have an EOSID trajectory for each departure procedure, without having to go through a secondary flight plan; to limit the costs owed to navigation database providers; to automatically propose the most relevant EOSID trajectory, in particular because of the orientation indicator; and also to be able to easily change the EOSID trajectory, between an EOSID trajectory generated in this way and an EOSID trajectory which would have been previously stored in the navigation database 22.

The flight management system 14 is then able to display the EOSID trajectory generated by the generating device 20 in the same way as an EOSID trajectory from the navigation database 22, and thus to take advantage of all the benefits of the EOSID option of the flight management system 14, including consistent predictions of aircraft status and allowing for the possibility of an engine failure, management of diversion points, displaying the EOSID trajectory together with the SID trajectory, and automatic activation in the event of engine failure(s).

The generating device 20 and the associated generating method also make it possible to limit the risk of input errors in the event of an EOSID procedure, compared to a situation where the EOSID trajectory is entered manually by the pilot, in particular if the pilot must determine this trajectory at a late stage or even in the emergency of an engine failure.

1. A method for generating at least one engine-out standard instrument departure trajectory, called EOSID trajectory, for at least one take-off runway, each EOSID trajectory being associated with a respective take-off runway, the method being implemented by an electronic generating device and comprising, for each take-off runway:
acquiring a set of characteristic(s) relating to the take-off runway, the set of characteristic(s) comprising an orientation of the axis of the take-off runway with respect to North;
calculating, from the acquired set of characteristic(s), at least one flight segment of a respective EOSID trajectory, the heading of each segment being defined with respect to the orientation of the take-off runway axis, the heading of each segment being an angle of predefined value with respect to said take-off runway axis; and
generating each EOSID trajectory from the calculated flight segment(s).

2. The method according to claim 1, wherein, during the calculating, several successive flight segments of the respective EOSID trajectory are calculated from the acquired set of characteristic(s).

3. The method according to claim 2, wherein among the plurality of successive flight segments of a respective EOSID trajectory, at least two segments have a heading with a different value from one segment to the other.

4. The method according to claim 2, wherein among the plurality of successive flight segments of a respective EOSID trajectory, at least two segments having a different type from one segment to the other.

5. The method according to claim 4, wherein the type of each segment is in accordance with ARINC 424.

6. The method according to claim 5, wherein the type of each segment is selected from the group consisting of: CD, CA, FD, FA, FM, FC, HM, HA and TF.

7. The method according to claim 1, wherein, during the acquiring, the set of characteristic(s) further comprise(s) a take-off runway altitude; and during the calculating, an altitude constraint of at least one flight segment of the respective EOSID trajectory is defined from a height relative to the take-off runway altitude.

8. The method according to claim 1, wherein each generated EOSID trajectory further comprises an orientation indicator, taken into account when selecting a respective EOSID trajectory among a plurality of EOSID trajectories associated with the take-off runway, the selection being made according to the positioning of said take-off runway among a plurality of take-off runways of a respective airport.

9. The method according to claim 1, wherein the heading value of a respective segment is changeable for at least one flight segment by a user.

10. The method according to claim 1, wherein each calculated flight segment further comprises a distance to be flown along said segment.

11. The method according to claim 10, wherein the value of said distance is predefined.

12. The method according to claim 10, wherein the value of said distance is changeable by a user.

13. A non-transitory computer-readable medium including a computer program comprising software instructions which, when executed by a computer, implement a method according to claim 1.

14. An electronic device for generating at least one engine-out standard instrument departure trajectory, called EOSID trajectory, for at least one take-off runway, each EOSID trajectory being associated with a respective take-off runway, the device comprising:
an acquisition module configured to acquire, for each take-off runway, a set of characteristics relating to the take-off runway, the set of characteristic(s) comprising an orientation of the axis of the take-off runway with respect to North;
a calculation module configured to calculate, for each take-off runway and from the acquired set of characteristic(s), at least one flight segment of a respective EOSID trajectory, the heading of each segment being defined with respect to the orientation of the take-off runway axis, the heading of each segment being an angle of predefined value with respect to said take-off runway axis; and
a generating module configured to generate, for each take-off runway, each EOSID trajectory from the calculated flight segment(s).

15. An electronic system selected from an aircraft flight management system and a non-aircraft on-board tablet system implementing flight management or optimisation functions, comprising an electronic generating device according to claim 14, the device being configured to generate, for at least one take-off runway, at least one engine-out standard instrument departure trajectory of the aircraft.
